(19) United States
(12) Patent Application Publication
(10) Pub. No.: US 2026/0128997 A1
(43) Pub. Date: May 7, 2026

(54) METHODS, ARCHITECTURES, APPARATUSES AND SYSTEMS FOR ENHANCING DATA BOOSTING USING LINKED QUALITY OF SERVICE FLOWS

(71) Applicant: InterDigital Patent Holdings, Inc., Wilmington, DE (US)

(72) Inventors: Xavier De Foy, Kirkland (CA); Michael Starsinic, Newtown, PA (US); Patrice Hirtzlin, Betton (FR); Magurawalage Chathura Madhusanka Sarathchandra, London (GB); Rocco Di Girolamo, Laval (CA); Francois Periard, Montreal (CA); Jaya Rao, Montreal (CA); Achref Methenni, Montreal (CA)

(21) Appl. No.: 18/940,192

(22) Filed: Nov. 7, 2024

(51) Int. Cl. H04L 47/2483

(52) U.S. Cl. CPC H04L 47/2483

(57) ABSTRACT

Procedures, methods, architectures, apparatuses, systems, devices, and computer program products relating to linked QoS flow (LQF) configuration and/or operation. A method may include receiving LQF configuration information indicating any of (1) one or more QoS flows (2) a mutually exclusive indication indicating that the QoS flows are used mutually exclusively, (3) an identifier associated with a LQF group comprising the QoS flows. The method may include setting up the QoS flows based on the LQF configuration information, receiving a data unit comprising an urgency indicator indicating an urgency associated with the data unit and a QoS flow in the LQF group, selecting an active LQF based on the urgency indicator, and transmitting the data unit over the active LQF.

### FIELD

Example embodiments described in the present disclosure are generally directed to the fields of communications, software and encoding, including, for example, to methods, architectures, apparatuses, systems related to enhancing, extending and/or improving data boosting using linked quality of service (QoS) flows.

### BACKGROUND

It is challenging for wireless networks to carry media flows, especially flows for applications with high-throughput and low latency requirements. Such applications may include, for example, video conferencing and extended reality (XR) applications. Wireless networks should implement techniques to improve network capacity and energy efficiency, as well as reduce the impact of packet losses on the user experience.

### SUMMARY

Some embodiments may be directed to a wireless transmit/receive unit (WTRU) that includes circuitry, such as any of a processor, memory, transmitter and receiver. The circuitry may be configured to receive linked quality of service (QoS) flow (LQF) configuration information indicating any of (1) one or more QoS flows (2) a mutually exclusive indication indicating that the QoS flows are used mutually exclusively, (3) an identifier associated with a linked QoS flow (LQF) group comprising the QoS flows; set up the QoS flows based on the linked QoS flow (LQF) configuration information; receive a data unit comprising an urgency indicator indicating an urgency associated with the data unit and a QoS flow in the linked QoS flow (LQF) group, or receive a data unit comprising a QoS flow identifier associated with a QoS flow in the linked QoS flow (LQF) group; select an active linked QoS flow (LQF), based on the urgency indicator or the QoS flow identifier; and transmit the data unit over the active linked QoS flow (LQF).

Some embodiments may include a method implemented by a WTRU. The method may include receiving linked quality of service (QoS) flow (LQF) configuration information indicating any of (1) one or more QoS flows (2) a mutually exclusive indication indicating that the QoS flows are used mutually exclusively, (3) an identifier associated with a linked QoS flow (LQF) group comprising the QoS flows; setting up the QoS flows based on the linked QoS flow (LQF) configuration information; receiving a data unit comprising an urgency indicator indicating an urgency associated with the data unit and a QoS flow in the linked QoS flow (LQF) group, or receive a data unit comprising a QoS flow identifier associated with a QoS flow in the linked QoS flow (LQF) group; selecting an active linked QoS flow (LQF), based on the urgency indicator or the QoS flow identifier; and transmitting the data unit over the active linked QoS flow (LQF).

Some embodiments may be directed to a network element that includes circuitry, such as any of a processor, memory, transmitter and receiver. The circuitry may be configured to receive linked quality of service (QoS) flow (LQF) configuration information indicating any of (1) one or more profiles associated with QoS flows (2) a mutually exclusive indication indicating that the QoS flows are used mutually exclusively, (3) an identifier associated with a linked QoS flow (LQF) group comprising the QoS flows; set up the QoS flows based on the linked QoS flow (LQF) configuration information; receive a data unit with an associated QoS flow identifier corresponding to one of the QoS flows in the linked QoS flow (LQF) group; select, based on the associated QoS flow identifier, an active linked QoS flow (LQF) for the data unit; and transmit the data unit over the selected active linked QoS flow (LQF).

Some embodiments may include a method implemented by a network element. The method may include receiving linked quality of service (QoS) flow (LQF) configuration information indicating any of (1) one or more profiles associated with QoS flows (2) a mutually exclusive indication indicating that the QoS flows are used mutually exclusively, (3) an identifier associated with a linked QoS flow (LQF) group comprising the QoS flows; setting up the QoS flows based on the linked QoS flow (LQF) configuration information; receiving a data unit with an associated QoS flow identifier corresponding to one of the QoS flows in the linked QoS flow (LQF) group; selecting, based on the associated QoS flow identifier, an active linked QoS flow (LQF) for the data unit; and transmitting the data unit over the selected active linked QoS flow (LQF).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example signaling diagram, according to some embodiments;

FIG. 3A illustrates an example flow diagram of a method, according to an embodiment; and

FIG. 3B illustrates an example flow diagram of a method, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

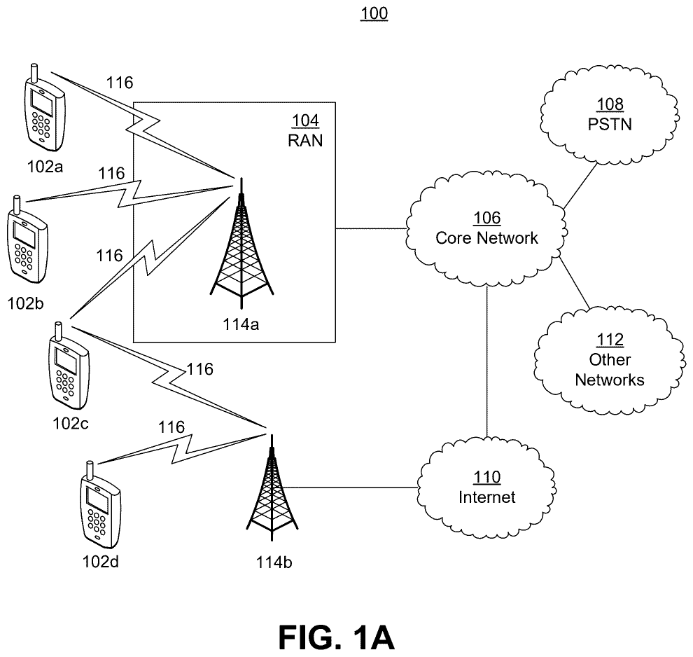

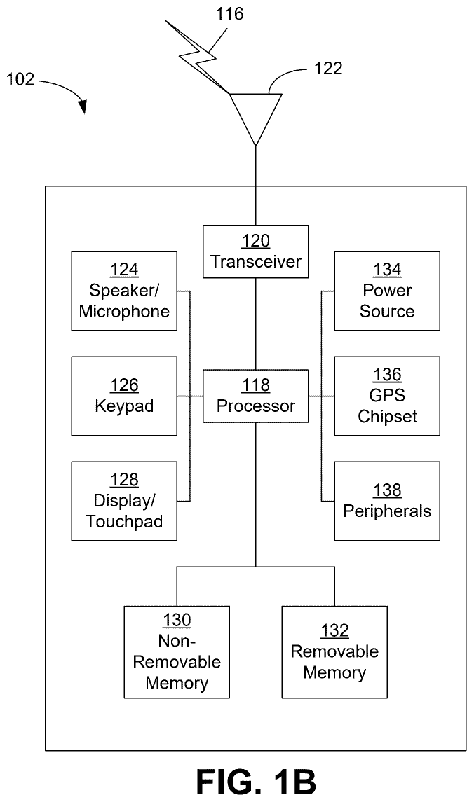

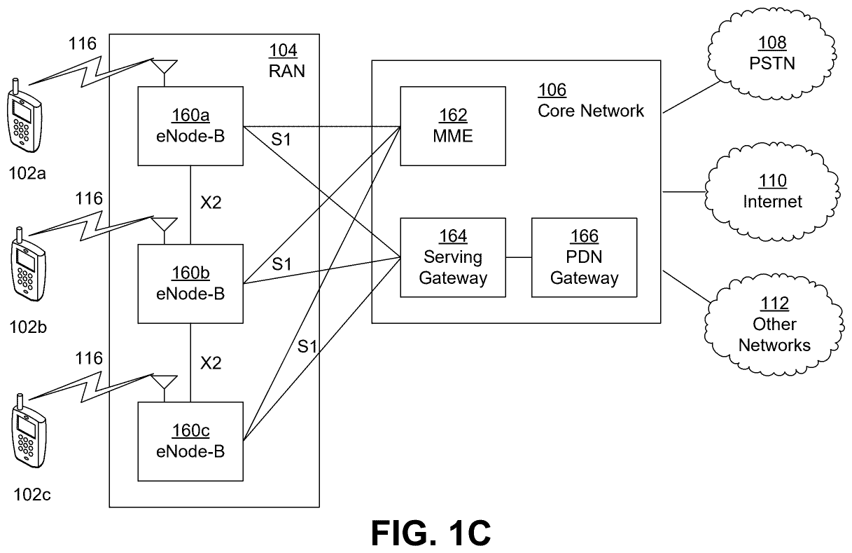

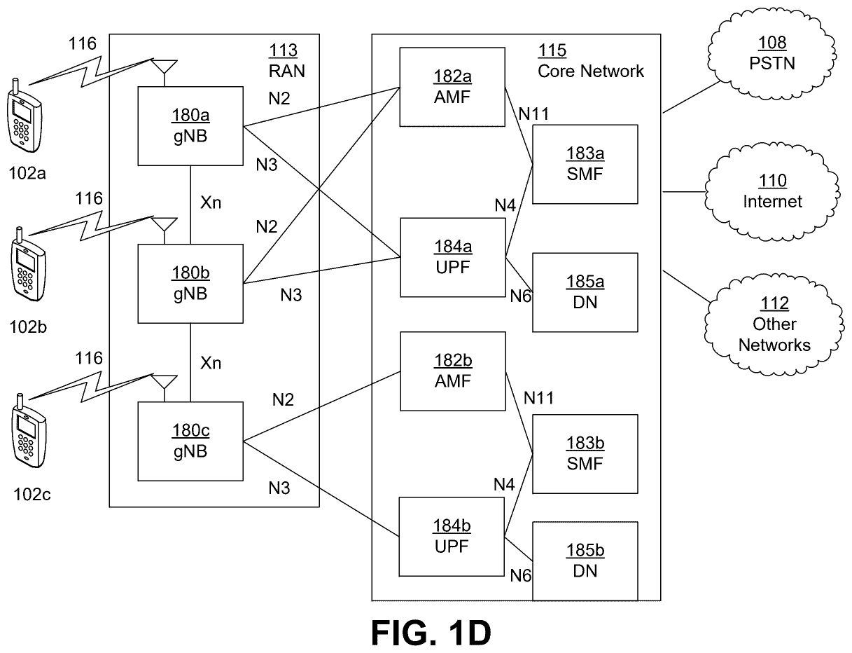

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA20001X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

The term RAN node may be used herein to represent any RAN node such as, but not limited to, a base station, gNodeB (gNB), and/or eNodeB (eNB) or the like.

It is noted that the following terms may be used interchangeably: linked flows, linked SDFs, mutually exclusive (ME) flows, ME SDFs.

The term “reporting” may be used herein to indicate the reporting of usage information to the network, and may include incrementing counters (e.g., bytes or packets used, packet lost, packets dropped, etc.) and reporting to the network by sending messages to the network (e.g., to the RAN node, to the SMF, etc.).

The terms Application Server (AS) and Application Function (AF) may be used interchangeably herein. An AS may in some cases be an Edge Application Server, for example. The term user plane function or “UPF” as used herein may generally designate a PSA UPF, unless specified otherwise.

The term Information Element (IE) may be used herein to represent one or more parameters. An IE may be made up of one or more other IEs.

The terms “packet” and “IP packet” may be used interchangeably herein. They may designate a protocol data unit (PDU) for a protocol such as an Internet layer protocol such as IPv4 or IPv6b, a transport protocol such as user datagram protocol (UDP), a layer-2 protocol such as Ethernet or 802.11, or an information centric networking protocol such as the Named Data Networking protocol.

It is challenging for wireless networks to carry media flows, especially for applications with high-throughput and low latency requirements, such as video conferencing and Extended Reality (XR). Wireless networks can implement techniques to improve network capacity and energy efficiency, as well as reduce the impact of packet losses on user experience. One such technique is “data boosting,” which may also be referred to as “expedited forwarding,” where the sending application marks packets that need to be handled with a higher QoS.

The data boost feature (also known as expedited forwarding) is configured by an AF by providing, along with a request for an AF session with QoS, two sets of QoS requirements (e.g., normal and expedited). As a result, the 5G system (5GS) creates two policy and charging control (PCC) rules, corresponding to each set of QoS requirements. Then, these PCC rules are used to configure a protocol data unit (PDU) session with a normal QoS flow and an expedited QoS flow. During the lifetime of the service, the user plane function (UPF) forwards downlink (DL) traffic (or data) on the normal QoS flow by default, unless it identifies the expedited transfer indication in a PDU, in which case the UPF transmits the PDU over the expedited QoS flow. Furthermore, when reflective QoS is used, the UE sends uplink (UL) traffic (or data) on the same QoS flow as the most recent DL PDU when the reflective QoS indication is set.

The data boost feature may be extended to use more than two QoS flows. For example, multiple QoS requirements corresponding to multiple PDU urgency indication values may be configured by the AF and may be used to configure PCC rules including these more than two QoS requirements and urgency values. The PCC values may be used to configure a PDU session with several QoS flows, each corresponding to different QoS requirements and urgency values. During the lifetime of the service, the UPF identifies the value of the urgency indication in a DL PDU and transmits the PDU over to the QoS flow corresponding to the urgency value.

The mechanisms and procedures described herein can be used to enhance the data boost feature, the extended data boost feature, and/or other similar features based on a user plane indication influencing the selection of the QoS treatment of PDUs. The user plane indication is designated herein as an urgency indication and may be an expedited transfer indication or urgency indication.

The QoS requirements for a service data flow (SDF) can vary over time, e.g., between a higher QoS requirement state and a lower QoS requirement state, based on conditions detected at a higher layer (e.g., application or transport layer).

In a first use case, the goal is to maintain the quality of experience (QoE) for the end user, where the QoE is dependent on a stable timing over a feedback loop at the application level. Some applications (e.g., extended reality (XR), augmented reality (AR), and/or virtual reality (VR)) involve multiple low-latency flows (e.g., pose, video, audio, haptics) that collectively participate in the QoE for the end user. In such a scenario, the feedback loop includes a WTRU transmitting pose information to an AS, the AS generating a scene and/or a video stream, and the AS transmitting the scene or stream to the WTRU, where the WTRU may display the resulting video frames to the user. In this example, if the pose arrives late at the server, the DL portion of the feedback loop should have lower latency to maintain the overall loop latency.

In a second use case, the goal is to improve QoE of media application transmitted over reliable transport protocols (e.g., over Media over QUIC (MOQ)), by speeding up transmission of re-transmitted PDUs. Since it takes time for the receiver to detect a lost PDU, and since lost PDUs prevent the reception of any subsequent PDU payload by the application, acknowledgements and re-transmitted PDUs may be transmitted with a lower latency to limit the impact of packet loss on application QoE.

Today, these use cases can be partially addressed by the data boost feature. Some PDUs are marked as “boosted” by the sender, and the network may use a different QoS flow for boosted PDUs.

Within the context of the first use case, for example, the application layer keeps track of the timing and whether a particular roundtrip interaction would be on time or delayed. The application sets an urgency indication in the PDUs it sends, e.g., 0 for normal, 1 for boost. The UPF (DL) or WTRU (UL) can identify the urgency of a PDU based on this indication and may select one LQF of the group to forward the PDU. For example, the AS application determines that the pose was received late, or that the processing time was longer than usual for this frame. The AS marks the DL PDUs carrying the frame with high urgency to meet the roundtrip loop target latency. The WTRU application predicts that a particular change of pose is likely to require more processing. The WTRU then marks the UL PDUs carrying pose information with high urgency. The WTRU application receives the previous video frame late and, based on this, predicts that the next frame will be late. The WTRU then marks the UL PDUs carrying pose information with high urgency. The AS application predicts that the next frame is likely to require a long processing time. In a case where the reflective QoS feature is used, the AS can send the last PDU of a video frame with high urgency, to trigger the WTRU to send the next UL PDU carrying pose information with high urgency.

Today, the data boost feature has a limitation that, since the RAN is not aware that the two QoS flows are related, the RAN will reserve resources for multiple QoS flows and assume that both QoS flows need to be supported simultaneously. This is an issue at least for admission control since, from the RAN standpoint, to establish the two QoS flows, the sum of all resources needed for each QoS flow need to be available. For example, this can be an issue during a mobility event, since a RAN node may reject the establishment of one QoS flow and not the other, resulting in a failure or a loss of QoE for the user.

Furthermore, knowing that both QoS flows will not be used simultaneously can enable optimizations of the RAN and/or WTRU implementation, and can enable an improved handling of the group of QoS flows, including for example reporting and managing the flows.

Finally, the use cases may benefit from more than two different QoS requirements being available for carrying the application flow, and therefore the data boost feature should be expanded to use more than two QoS flows.

A solution is therefore desired, where multiple QoS flows can be used to transmit a service data flow (SDF) with a variable QoS requirement, and where a linkage between these QoS flows is configured in the 5GS, for example, for use by the RAN for admission control, improved group handling and optimizations. In certain embodiments, this new feature may be referred to herein as linked QoS flows (LQF).

As will be discussed in more detail in the following, according to certain embodiments, an application function (AF) or other network element may configure, e.g., into a NEF/PCF, a set of mutually exclusive service data flows (SDFs) associated with different QoS requirements and/or other configuration information elements (IEs). The PCF may create or update policy and charging control (PCC) rules based on this configuration and may provide the rules to a session management function (SMF) or node. The SMF may configure the user plane function (UPF), radio access network (RAN) node and/or WTRU with a group of LQFs based on the PCC rules. On UL and/or DL, an active LQF is selected for each PDU, and used to forward the PDU. The RAN node uses the mutually exclusive nature of the group of linked QoS flows (LQFs) to provide accurate admission control. The RAN node and/or WTRU can use the mutually exclusive nature of the group of LQFs for improved group handling and optimizations. The UPF, RAN node and/or WTRU can enforce some aspects of non-concurrency of the LQFs. The RAN node can advertise its support for LQF groups to enable heterogenous support for this feature in the network.

As a result of some example embodiments, an AF may be aware of SDFs that are mutually exclusive, can configure a NEF and/or PCF with the mutually exclusive SDFs and, in the 5GS (e.g., RAN) a set of mutually exclusive LQFs can be defined to properly handle the SDFs.

Hence, example embodiments can enhance the AF session with QoS procedure to enable a mutually exclusive indication (and related IEs) to be provided to the network, to enable the RAN to accurately perform access control, as well as additional LQF-related actions, optimizations and/or improvements.

Some embodiments may include or may be directed to LQF group(s) configuration and operation. As discussed in more detail below, certain embodiments provide procedures that enhance the current procedure of data boost (or extended data boost using more than two QoS flows), by enabling access control to accurately account for the fact that LQFs are not active at the same time (e.g., are mutually exclusive). Additional LQF-related actions are also enabled (e.g., group monitoring and reporting, optimizations), according to certain embodiments.

In an embodiment, a RAN node may receive a configuration message (e.g., an N2 message) that may include LQF configuration information or IEs. For example, the LQF configuration information or IEs may include any one more of a list of QoS flow profiles (e.g., a profile associated with each QoS profile), a mutually exclusive indication (e.g., to indicate that QoS flows in a LQF group are not active at the same time), LQF transition timing, priority, degraded mode indication, and/or LQF group identifier (ID).

According to an embodiment, the RAN node may configure the QoS flows and configure an LQF group based on the LQF configuration information or IEs. In other words, in an embodiment, the RAN node may setup the QoS flows based on the LQF configuration information. For example, the RAN node may setup the QoS flows based on any of: one or more profiles associated with the QoS flows, respectively, the mutually exclusive indication indicating that the QoS flows are used mutually exclusively (e.g., are not active at the same time), and/or the ID associated with the LQF group that includes or is made up of the QoS flows.

In an embodiment, the RAN node may apply optimizations based on the mutually exclusive indication and/or other LQF configuration IEs.

According to an embodiment, the RAN node may receive a data unit (e.g., PDU, packet, or other data) with an associated QoS flow identifier (QFI) (e.g., included in GTP header) corresponding to a member of the LQF group (e.g., a QoS flow in the LQF group).

In an embodiment, the RAN node may select the active LQF based on the associated QFI, based on the characteristics of a currently active LQF, and/or based on LQF group configuration information or IEs (e.g., minimum selection time and priority). According to certain embodiments, if the selected LQF is determined or considered invalid, the RAN node may send an error indication to the SMF, and/or the RAN may drop the PDU, and/or may select the currently active LQF.

According to an embodiment, the RAN node may update counters (e.g., associated with a number of packets or bytes used) related to the LQF group, e.g., for later reporting of LQF group statistics to the network (e.g., SMF).

In an embodiment, the RAN node may forward the PDU over the active LQF.

According to an embodiment, the RAN node may perform access control operations using the LQF group characteristics and/or LQF configuration information (IEs), e.g., instead of individual QoS flow characteristics.

As discussed in more detail below, certain embodiments provide procedures that enhance data boost (or extended data boost using more than two QoS flows), for example, by enforcing some constraints on the selection of the LQFs, such as non-concurrency, timing, priority.

In an embodiment, the UPF may receive a message (e.g., an N4 message) that may include LQF configuration information or IEs. For example, in some embodiments, the LQF configuration information or IEs may include a mutually exclusive indication and/or a list of DL packet detection rules (PDRs), each corresponding to a LQF. Additionally, in some embodiments, the LQF configuration information or IEs may include IEs related to LQF transition timing, priority, degraded mode indication, and/or LQF group ID. According to some embodiments, the LQF configuration information or IEs may also include a protocol descriptor indicating a method of identification of urgency/SDF.

According to an embodiment, the UPF may configure the DL PDRs and/or may configure an LQF group with LQF configuration IEs. For example, the UPF may configure the DL PDRs in accordance with or based on the LQF configuration information.

In an embodiment, the UPF may receive a DL PDU (or PDU set) matching a PDR from the list of DL PDRs, e.g., possibly using the protocol descriptor to identify the value of an urgency indicator present in the PDR. The UPF may receive messages from network nodes (e.g., NWDAF or RAN node) indicating a network state (e.g., congestion, failure modes, etc.).

According to an embodiment, the UPF may select the active LQF based on the matching PDR and/or on the LQF group (e.g., based on LQF group configuration information, such as the mutually exclusive indication, timing, priority aspects, etc.), and/or in some systems, also based on network state information. In an embodiment, the UPF may also perform usage monitoring and/or reporting for the LQF group.

In an embodiment, the UPF may forward the PDU (or PDU set) towards the RAN, along with the selected active LQF ID (e.g., by placing the selected active LQF QFI in a GTP header encapsulating the PDU) and/or, in some systems, with the LQF group ID or mutually exclusive indication.

According to some embodiments, a SMF may receive PCC rules including LQF configuration information or IEs. The SMF may send a message (e.g., N4 request message) to a UPF, which may include LQF configuration information or IEs that include or indicate a mutually exclusive QoS flow indication. The SMF may receive a message (e.g., an N4 response message) that may indicate the operation was successful. The SMF may send a configuration message to the WTRU, e.g., through the RAN, which may include LQF configuration information or IEs. For example, the configuration message may be an N2 message for the RAN node including a PDU session modification command message for the UE. The SMF may receive a response message, which may indicate that the RAN node is using the mutually exclusive QoS flow indication for LQF group optimizations such as accurate access control.

In certain embodiments, the SMF may additionally use the LQF group support indication from a RAN node to determine whether to use LQF groups. The SMF may additionally use the LQF group support indication from a RAN node, or a failure notification from the RAN, to determine that the LQF group is operating in degraded mode and notify the AF that the LQF group is operating in degraded mode.

As discussed in more detail below, certain embodiments provide procedures that enhance the data boost procedure (or extended data boost using more than two QoS flows), e.g., by enforcing some constraints on the selection of the LQFs, such as non-concurrency, timing, and/or priority, etc. This enforcement can enable the RAN node to accurately perform access control, and can enable the RAN and WTRU to perform LQF-related actions and optimizations.

According to an embodiment, a WTRU may receive a configuration message that may include LQF configuration information or IE(s). For example, the LQF configuration information or IE(s) may include or indicate a list of QoS flows rules and/or a mutually exclusive indication. The mutually exclusive indication may be to indicate that the QoS flows are to be used mutually exclusively (e.g., are not active at the same time). Additionally or alternatively, the LQF configuration information or IE(s) may include or indicate additional IE(s) related to LQF transition timing, priority, degraded mode indication, and/or LQF group ID. In some examples, the LQF configuration information or IE(s) may be received in or with a PDU session modification command message.

In an embodiment, the WTRU may configure or setup the included QoS flows and/or may configure an LQF group. In other words, the WTRU may setup, or otherwise configure or prepare, the QoS flows based on the LQF configuration information or IE(s) (e.g., based on information included in the LQF configuration information). For example, the WTRU may apply procedures or optimizations based on the mutually exclusive indication and/or other LQF configuration IEs. According to certain embodiments, the WTRU may report statistics for the whole LQF group (e.g., packet loss).

According to an embodiment, the WTRU may receive an UL PDU (or PDU set, packet(s), data) with an SDF/urgency corresponding to a member of the LQF group, or a DL PDU including a reflective QoS indication, with an QFI corresponding to a member of the LQF group.

In an embodiment, the WTRU may select an active LQF based on the SDF, urgency, and/or QFI. The selection may also depend on non-concurrency, timing, and/or priority constraints from the LQF configuration information or IEs. Based on the mutually exclusive indication, the WTRU may limit the rate of change of the active LQF (e.g., limit how often the WTRU switches between QoS flows). In some examples, the WTRU may furthermore use configuration IEs related to LQF transition timing and/or priority, to determine the selected active LQF.

According to an embodiment, the WTRU may update counters (e.g., counters associated with a number of packets or bytes that are used) related to the LQF group, e.g., possibly for later reporting of LQF group usage to the network.

In an embodiment, the WTRU may forward an UL PDU (or PDU set, packet, or data) over the active LQF.

According to certain embodiments, an AF (or network element) may configure, e.g., into a NEF and/or PCF (or other network element), a set of mutually exclusive SDFs associated with different QoS requirements and/or other configuration IEs. The PCF may create and/or update PCC rules based on this configuration and may provide the rules to the SMF. The SMF may configure the UPF, RAN node and/or WTRU with one or more LQFs (e.g., group of LQFs) based on the PCC rules. On UL and/or DL, an active LQF may be selected for each PDU, and used to forward the PDU. The RAN node may use the mutually exclusive nature of the group of LQFs to provide accurate admission control. The RAN node and/or WTRU can use the mutually exclusive nature of the group of LQFs for improved group handling and optimizations. The UPF, RAN node and/or WTRU can enforce some aspects of non-concurrency of the LQFs. The RAN node can advertise its support for LQF groups to enable heterogenous support for this feature in the network.

As discussed elsewhere herein, certain embodiments may include or provide LQF group configuration information or IE(s) (e.g., LQF configuration information). LQF group configuration IEs (also referred to as LQF configuration information or LQF configuration IEs herein) can be used in messages sent by a network element to another network element (e.g., messages sent by an AF to a PCF through NEF or directly), in PCC rules, and/or in messages, such as N4b, N2 and NAS messages. LQF configuration information or IE(s) may include one or more of: a list or indication of mutually exclusive SDFs, a protocol descriptor indicating how to identify an urgency indicator that can be used to differentiate between the mutually exclusive SDFs, a list or indication of QoS requirements corresponding to the mutually exclusive SDFs (e.g., to each of the mutually exclusive SDFs), an indication to use reflective QoS, a mutually exclusive indication to indicate the QoS flows are mutually exclusive (e.g., are not active at the same time or will not be active simultaneously), a selection time (e.g., minimum selection time) or transition timing, a preference order associated with the LQFs (e.g., associated with each LQF), parameters characterizing the timing and/or preference in an LQF group, a degraded mode enabled indication, an indication of QoS flows (e.g., set of QoS flows) that may be identified by a QFI, and/or a linked flow group ID which identifies a group of SDFs and/or LQFs.

In some embodiments, the QoS requirements may include a guaranteed bit rate (GBR), which is to be activated when (e.g., only when) the corresponding exclusive SDF is active.

According to certain embodiments, the mutually exclusive indication may indicate that the UPF (DL) and/or WTRU (UL) will not send PDUs in parallel over the LQFs. In other words, the mutually exclusive indication indicates that there is a single application flow, whose PDUs can be transmitted over any one of the LQFs. The mutually exclusive indication enables the RAN to improve the accuracy of access control. The mutually exclusive indication may be explicit, or it may be implicit (e.g., the grouping of SDFs, QoS requirements, or QoS flow IDs in a given type of message, or the presence of an LQF group ID in a message may indicate mutual exclusion implicitly).

In some embodiments, a selection time (or minimum selection time or transition time) indicates how long the UPF (DL) and/or RAN node (DL) and/or WTRU (UL) guarantee that a LQF will be used, after a first PDU is sent over this LQF. On one side, this means that in some cases (e.g., packet reordering happening in the network), some PDUs indicating an LQF may be transmitted over another LQF. On the other side, this enables characterizing non-concurrency over the LQF group, which can enable the access control by RAN to be accurate, as well as enable RAN and UE to perform optimizations.

According to an embodiment, the preference order associated with a LQF (e.g., each LQF) can be used by the UPF (DL) and UE (UL) to influence the LQF selection, e.g., select immediately a higher priority LQF when receiving a PDU indicating this LQF, and wait for receiving N PDUs indicating a lower priority LQF before switching back to the lower priority LQF. This reduces the chances that PDUs indicating a high priority LQF are transmitted over a low priority LQF, when enforcing a selection time (e.g., minimum selection time).

In an embodiment, other parameters characterizing the timing and/or preference in an LQF group may be present in addition to or in replacement of the (minimum) selection time and/or preference order, to enable controlling the enforcement of non-concurrency based on different constraints.

According to an embodiment, the degraded mode enabled indication indicates that the LQF group may (if TRUE) or may not (if FALSE) continue to be used in a case where one or more of the LQFs becomes unusable for a certain time. For example, if the degraded mode is enabled, and if failure condition occurs (e.g., a new RAN node does not support LQF groups, or some LQFs experience congestion or malfunction for an extended amount of time), the network may decide to continue providing the service, even if the PDUs cannot be forwarded over the proper active LQF. In other words, the degraded mode enabled indication may allow the network to switch between using the provisioned LQF group, and either using a subset of the original LQF group or not using an LQF group at all. The network may notify the AF when these switches occur.

In an embodiment, QoS flows (or a set of QoS flows) may be identified by a QFI and may be characterized by, e.g., QoS rules, QoS profiles, UL and/or DL PDRs.

According to an embodiment, a linked flow group ID identifies a group of SDFs and/or LQFs. When identifying a group of LQFs, the linked flow group ID can also be called LQF group ID. For example, when used in a message from the AF or PCC rule, the linked flow group ID may designate the group of mutually exclusive SDFs and related QoS requirements. For example, when used in a configuration message from SMF to UPF, RAN or WTRU, the linked flow group ID may be called a LQF group ID and may designate a group of mutually exclusive LQFs. In another example, a QoS Flow ID (QFI) may be used as a LQF group ID, i.e., a single QFI may be used to identify the whole group, e.g., in messages to add or remove an SDF to a LQF group ID. Individual LQF will still be identified by a QFI, e.g., the UPF may use an individual LQF QFI in the GTP header, to signal which LQF is associated with a PDU. The LQF group may therefore be handled as a “pseudo QoS flow” for the purpose of reporting data usage and performing management operations. In some examples, the LQF group ID may be implicitly signalled, e.g., by signalling the set of QoS flows together with a mutually exclusive indication, in which case the LQF group may be, for example, identified using the first QoS flow ID of the LQFs in the group.

In some embodiments, an AF (or other network element) may configure mutually exclusive (ME) SDFs in a NEF/PCF (or other network element). As such, certain embodiments may include the configuration of ME SDFs in PCC rules, for example, by an AF directly or through a NEF.

According to an embodiment, an AF may configure into the NEF/PCF a linked flow group, which may include a set of two or more SDFs (and associated QoS requirements) that are mutually exclusive. For example, the two or more SDFs may be distinguished by the value of an urgency indicator in each PDU (e.g., indicator in RTP HE, in MOQ metadata, in UDP option, IP header, etc.) The SDFs may be mutually exclusive in the sense that a single application flow is sent over one of the linked SDFs at any given time, and there is no concurrency, e.g., there is no multiplexing of multiple sub-flows over multiple linked SDFs. Some additional parameters may be provided by the AF to further characterize this non-concurrency, e.g., using timing or priority parameters. The AF session with QoS request message may include one or more LQF configuration IEs or information. In some embodiments, the AF session with QoS request message or the LQF configuration information or IE(s) may include any one or more of the following: a list of mutually exclusive SDFs, a protocol descriptor indicating how to identify the urgency of a PDU, a list of QoS requirements corresponding to each mutually exclusive SDFs, an indication to use reflective QoS, a mutually exclusive indication that may refer to the group of ME SDFs and may indicate that these SDFs are used for a single flow (not for multiple multiplexed flows), a minimum selection time, a preference order, a degraded mode enabled indication, and/or a linked flow group ID that refers to the group of ME SDFs and related QoS requirements.

Based on the configuration by the AF, the PCF may create or update one or more PCC rules that include the ME SDFs and/or other LQF configuration IEs. The PCF may notify the SMF about the modification of policies and provide the PCC rules to the SMF. The PCF may generate a QoS monitoring policy for the whole linked flow group and may provide the policy in the PCC rules to the SMF. The PCC rules may include one or more LQF configuration IEs. In some examples, the PCC rules may include any one or more of the following: a list of mutually exclusive SDFs, a protocol descriptor indicating how to identify the urgency of a PDU, a list of QoS requirements corresponding to each mutually exclusive SDFs, an indication to use reflective QoS, a mutually exclusive indication that refers to the group of ME SDFs and/or indicates that these SDFs are used for a single flow (not for multiple multiplexed flows), a transition timing or (minimum) selection time, a preference order, a degraded mode enabled indication, and/or a linked flow group ID that refers to the group of ME SDFs and/or related QoS requirements.

In an embodiment, the network operator may configure PCC rules in the PCF, as an alternative to configuring PCC rules based on a request from the AF, that define an LQF group and/or that include LQF group configuration IEs (e.g., based on a business agreement).

The operation of an LQF group may reach a degraded mode in some cases. For example, following a mobility event, the WTRU connects to a RAN node which does not support LQF groups; in another example, one or more LQFs of the LQF group become non-operational (e.g., overly congested, or in a failure mode). As a result of one of those cases, a node (e.g., SMF, RAN, or WTRU) may determine whether to stop providing the service or continue in degraded mode, e.g., based on the LQF group degraded mode enabled indication. The node may trigger (e.g., through the PCF) a notification to be sent to the AF (or other network element), to indicate a degraded mode. If the LQF group becomes completely operational again (e.g., following another mobility event where the UE connects to a RAN node which supports LQF groups), the node may trigger another notification to be sent to the AF, to indicate the end of the degraded mode.

In some embodiments, a SMF (or network element) may configure UPF, RAN and/or WTRU with LQFs and/or LQF configuration information or IE(s).

According to an embodiment, upon receiving PCC rules including LQF group configuration IEs, the SMF may apply the new and/or modified PCC rules to PDU session(s). This application can include creating new QoS flows, associating an SDF for each created QoS flow, where the created QoS flows are part of an LQF group. This application can include updating existing QoS flows, adding an SDF on each updated QoS flow if not already present, and/or including the QoS flow in an LQF group.

In some embodiments, the SMF may restrict the QoS flows member of an LQF group to be used (e.g., only be used) for carrying the traffic of the LQF group, e.g., the SMF may limit the number of SDFs for each LQF to one. This limitation can be useful to ensure that the LQFs of the LQF group are mutually exclusive, which enables the RAN to perform accurate admission control as described herein.

According to an embodiment, the SMF may send messages to configure the RAN, WTRU and/or UPF, including LQF configuration IE(s) in the messages. The SMF may send a message (e.g., an N4 message) to the UPF, to configures the UPF with LQF configuration IEs. The SMF may send a message (e.g., N2/NAS message, such as a N2 SM information message including a NAS message) to the WTRU and/or RAN, to configure the RAN node and/or the WTRU with LQF configuration IE(s). The SMF may configure (e.g., in N4 and N2/NAS messages) the UPF and RAN to use reflective QoS for the LQF group, which enables the AS to influence the active LQF for UL PDUs.

In an embodiment, the SMF may send a NAS message, to the WTRU, to configure the WTRU with QoS rules corresponding to LQFs of the LQF group. The SMF may configure the WTRU with a protocol descriptor to identify the urgency identification in PDUs. The SMF may configure the WTRU to select an active LQF based on the urgency value for a PDU, and/or other LQF related actions.

According to some embodiments, a message sent to configure any of the network elements described herein, such as an N4 message, may include one or more LQF configuration information or IE(s). In certain embodiments, the message or LQF configuration information may include any one or more of the following: one or more QoS flows (e.g., a set of QoS flows) that may each be identified by a LQF ID (e.g., QFI) and may be characterized by UL and DL PDRs, a protocol descriptor indicating how to identify the urgency of a PDU, an indication to use reflective QoS, a mutually exclusive indication that refers to the QoS flows signalled in the message and indicates that they are used for a single flow (not for multiple multiplexed flows), a minimum selection time, a preference order, a degraded mode enabled indication, and/or an LQF group ID that refers to the QoS flows signalled in the message (e.g., N4 message).

Upon receiving the message (e.g., N4 message), the UPF may configure itself using the LQF group configuration IEs to identify the SDFs corresponding to the LQFs from the LQF group. For example, this may include any one or more of: identifying the urgency indication in PDUs (e.g., using a protocol descriptor from the LQF group configuration IEs), selecting the active LQF for the LQF group, enforcing non-concurrency between LQFs, performing usage reporting for the LQF group, forwarding the PDUs to the RAN in (e.g., GTP-U) messages including a LQF ID (e.g., QFI), and/or in some cases also including a LQF group ID.

In an embodiment, the message sent to the WTRU and/or RAN (e.g., N2/NAS message) may include one or more LQF configuration IEs. In certain embodiments, this message (e.g., N2/NAS message) may include any one or more of the following: a set of QoS flow identified by a LQF ID (e.g., QFI) and/or characterized by QoS profiles and/or QoS rules, a mutually exclusive indication that refers to the QoS flows signalled in the message and may indicate that they are used for a single flow (not for multiple multiplexed flows), a transitioning timing or (minimum) selection time indication, a preference order, a degraded mode enabled indication, and/or an LQF group ID that may refer to the QoS flows signalled in the message (e.g., N2/NAS message).

According to an embodiment, upon receiving the message (e.g., N2/NAS message), the RAN node configures itself using the LQF group configuration information or IE(s), to perform the actions described herein, including but not limited to, e.g., accurately performing LQF group-aware access control, enforcing non-concurrency between LQFs for DL traffic, detecting and handling degraded mode, handling LQF group reporting, and/or implementing LQF group-based optimizations.

In some embodiments, upon receiving the message (e.g., N2/NAS message), the WTRU may configure itself using the LQF group configuration information or IE(s), to perform the actions described herein, including but not limited to, e.g., identifying the urgency indication in PDUs (e.g., using a protocol descriptor from the LQF group configuration IEs), enforcing non-concurrency between LQFs for UL traffic, detecting and handling degraded mode, handling LQF group reporting, and/or implementing LQF group-based optimizations.

In some embodiments, a RAN may use LQFs including for access control and reporting. For example, a RAN node may make use of LQFs for non-concurrency enforcement, LQF grouping-related actions, such as access control and reporting, handling of degraded mode, and/or optimizations.

According to certain embodiments, the RAN node may configure or setup LQFs and/or the LQF group. The RAN node may configure each QoS flow in the LQF group as usual. The RAN node may store grouping information in its internal state, obtained from the SMF as previously described. Grouping information can include any LQF group configuration information or IE(s), including for example any one or more of: a list of the LQFs in the group (e.g., including QFI of the LQFs), a mutually exclusive indication that may refer to the LQFs in the group, a LQF group ID, a minimum selection time, a preference order, and/or a degraded mode enabled indication.

In some embodiments, the RAN node can perform one or more LQF grouping-related actions based on grouping information, for example, including any of the following.

The RAN node may use an LQF group as a pseudo QoS flow, for PDU queueing operations and/or for calculating characteristics of PDU sessions or network usage. The RAN node may, for those operations, replace each LQF members of the LQF group with a single pseudo QoS flow. The pseudo QoS flow characteristics may include a priority level, PDB, PER, averaging window, and/or maximum data burst volume. The values for the characteristics of a pseudo QoS flow may, depending on the purpose of the calculation, be set to the maximum, minimum, average, or another combination of the values of the corresponding characteristic of all members of the LQF group. Examples of usage for LQF group characteristics include Access Control and reporting described hereinafter.

The RAN may use the LQF group to accurately perform access control and/or reporting during the lifetime of the service. For example, the RAN node may use a pseudo QoS flow corresponding to the LQF group, for access control. The RAN node may use the radio resource usage of the LQF group to perform access control operations, not the individual radio resource usage of each LQF. Access control operations include, for example, RACH back off, RRC Connection Reject, RRC Connection Release and UE based access barring mechanisms. For example, for access control, the RAN node can determine the (e.g., estimated or potential) radio resource usage of the LQF group, by considering, for each type of resource, the largest (e.g., estimated or potential) usage by an individual LQF in the group (i.e., not the sum of all resources used by each LQF).

In some embodiments, a GBR may be associated with LQFs, which enables the RAN to activate GBR only for active LQF, while GBRs configured on currently inactive LQFs are not activated. This enables GBR to be used with data boosting, which is currently not allowed.

According to an embodiment, the RAN node may use an LQF group as a pseudo QoS flow for monitoring usage, and/or for reporting usage to the SMF. For example, if the GBR could not be met on the active LQF, the RAN node may send an indication that the GBR cannot be met for the LQF group.

In some embodiments, the RAN node and/or WTRU may implement an LQF group as a pseudo QoS flow, which is dynamically reconfigured when the active LQF changes. This type of implementation may be performed as an optimization, enabling using fewer (e.g., computing and memory) resources than implementations based on regular QoS flows. In an embodiment, a RAN node (DL) or WTRU (UL) can reconfigure the resource blocks each time the active LQF changes in a LQF group. For example, SDAP mapping, logical channel priority/prioritized bit rate (PBR)/buffer size duration (BSD), and/or the number of configured grants may change during this reconfiguration.

According to an embodiment, on the UL, the WTRU may implement LQF-related actions similar to the RAN node LQF-related actions described hereinbefore. For example, the WTRU may activate GBR for the active LQF flow of an LQF group, and disable the GBR of inactive LQF flows; the WTRU may use an LQF group as a pseudo QoS flow for monitoring usage, and/or for reporting usage to the network; in some embodiments, the WTRU may implement an LQF group as a pseudo QoS flow, which is dynamically reconfigured when the active LQF changes.

Some embodiments may include or relate to the data plane operation of DL and/or UL LQFs. In an embodiment, the UPF, RAN node and/or WTRU may select the active LQF and forward PDUs using the active LQF, during the lifetime of the service. Selection of an active LQF by UPF, RAN and/or WTRU can use LQF configuration information or IE(s), such as mutually exclusive indication and IEs related to timing and/or priority between LQFs, as discussed above.

In an embodiment, the sending application (e.g., AS application or WTRU application) may send application units (e.g., media units) in PDUs that include an urgency indication. The sending application may determine the urgency indication value of PDUs based on (e.g., latency) measurements and/or predictions, related to time spent for computation and transmission. The latency measurements/predictions may be local (e.g., measured/predicted on AS or UE), and/or provided by other nodes (e.g., WTRU, AS, NWDAF or other AF). The urgency values can be determined with the goal to adjust the QoS for the PDUs in order to maintain the QoE for the end user, as described above. In some embodiments, the sending application may use other types of inputs (e.g., information on network state, on end user status, in-application context) and/or other types of goals (e.g., enabling synchronization between multiple receivers).

According to an embodiment, on the DL, upon receiving a DL PDU, the UPF may match the PDU against a traffic filter and may identify an urgency indication in the PDU (e.g., based on a protocol descriptor). The UPF may match the PDU against a PDR that is associated with (e.g., contains) LQF configuration IEs. The UPF can encapsulate the PDU in a GTP header that includes LQF configuration IEs (e.g., LQF ID and/or LQF group ID and/or mutually exclusive indication). Upon receiving the GTP-encapsulated PDU, the RAN node can use the LQF ID (e.g., a QFI) to forward the PDU to the WTRU. The RAN node may also (e.g., using the mutually exclusive indication and/or LQF group ID) look up to which LQF group the PDU belongs to. The RAN node may store information into a data structure associated with the looked up LQF group (e.g., PDU or byte count total and/or per-LQF, events and errors), e.g., for reporting to the core network. The RAN node may also use the looked up LQF group to perform non-concurrency enforcement and/or other LQF grouping-related actions described hereinbefore.

In an embodiment, on the UL, upon receiving an UL PDU (e.g., from a WTRU application), the WTRU may match the PDU against a traffic filter and may identify an urgency indication in the PDU (e.g., based on a protocol descriptor). The WTRU may match the PDU against a QoS rule that is associated with (e.g., contains) LQF configuration IE(s). The WTRU may transmit the PDU down the communication stack (e.g., to the SDAP layer) along with LQF configuration IE(s) (e.g., LQF ID and/or LQF group ID and/or mutually exclusive indication). The WTRU may use the LQF ID to forward the PDU to the RAN node. The WTRU may also (e.g., using the mutually exclusive indication and/or LQF group ID) look up to which LQF group the PDU belongs to. The WTRU may store information into a data structure associated with the looked up LQF group (e.g., PDU or byte count total and/or per-LQF, events and errors), e.g., for reporting to the network. The WTRU may also use the looked up LQF group to perform non-concurrency enforcement and/or other LQF grouping-related actions described hereinbefore.

According to some embodiments, network state information may further be used to determine the active LQF. For example, the WTRU and/or UPF may receive messages from network nodes (e.g., NWDAF, RAN node) that indicate a measured or predicted network state (e.g., congestion, failure mode). The UPF and/or WTRU may use the indicated network state, along with information contained in the PDU (e.g., urgency indication value) to determine the active LQF. Network state information may be useful, for example, to increase the QoS provided to certain flows, to maintain the user QoE despite a temporary poor network condition.

In some embodiments, identification of SDF/urgency by UPF and/or WTRU can be based on parsing a UDP option, IP header, or at the application layer (MOQ, RTP HE). For example, based on the configuration received by UE/UPF from SMF, the WTRU/UPF may select a first SDF if the PDU urgency indication value is 0, a second SDF if the PDU urgency indication value is 1, and so on. For UL, if not using reflective QoS, identification may in some examples be through a programmatic API (QUIC API, socket API). For UL, if the reflective QoS indication is used on DL PDUs, the WTRU can also identify the desired active LQF based on the last DL PDU received on a QoS flows of the LQF group with a QoS indication. Furthermore, in some cases the urgency value may be a PDU set IE, which may be a new field in PDU set information (e.g., in an RTP header extension for PDU sets, or in a MOQ PDU set metadata). In such cases, the UPF and/or WTRU may read or determine the urgency value during the PDU set identification process, and then can use the urgency value to select the active LQF for the whole PDU set.

According to certain embodiments, the WTRU, UPF and/or RAN node (which may be called enforcement node herein) may in some examples perform enforcement of non-concurrency for PDUs, based on grouping information, to ensure that the constraints of the LQF group stay valid over time. In some embodiments, enforcement of non-concurrency for DL PDUs may be performed in the UPF, in the UPF and RAN node, or in just the RAN node. In a case where both the UPF and RAN node perform DL enforcement, the role of enforcement in the RAN may for example be a sanity check, that ensures that the decision from the UPF was compliant with the LQF group configuration IEs. Enforcement of non-concurrency for UL PDUs may be performed in the WTRU. Enforcement of non-concurrency can help, for example, ensuring that using the LQF group for access control is accurate.

To enforce non-concurrency, the enforcement node can, for example, use a single queue for all PDUs of the LQF group, and/or the enforcement node can enforce some conditions for switching from one LQF to another LQF of the group. For example, the enforcement node may determine a PDU belongs to the LQF group (e.g., based on the LQF group ID), and then may determine if the candidate LQF indicated by the PDU (e.g., PDU urgency indication) is the currently active LQF. If the candidate LQF is not the active LQF, the enforcement node can check if the timing from the last change of active LQF is longer than the LQF group minimum selection time and keep the currently active LQF unchanged if it is shorter. If the candidate LQF is not the currently active LQF, the enforcement node can also use the preference order of the currently active LQF versus preference order of the candidate LQF to make the decision to keep or change the active LQF (e.g., switch to higher priority active LQF immediately, or stay on the higher priority active LQF until several PDUs corresponding to the lower LQF are received). A reason for selecting the active LQF using timing and/or preference is to not only enforce that the active LQF stays active long enough to reduce churn in the RAN node, but also limiting any negative effect of this enforcement on traffic, e.g., by keeping cases where a high urgency PDU is sent over a default LQF to a minimum.

In some embodiments, the RAN may advertise its support for LQF groups, for example, to the core network (e.g., to the SMF). In an embodiment, the RAN node may provide an LQF group support indication. For example, in some cases, the LQF group support indication may be with heterogenous LQF group support. The LQF group support indication may be provided or sent during a PDU session establishment or modification procedure, for example, in a N2 PDU session response message from RAN to SMF through AMF. The RAN node may determine to send an LQF group support indication to the SMF, e.g., if the SMF transmits LQF configuration IEs to the RAN in an earlier message (e.g., a PDU session establishment response or PDU session modification command message). Upon receiving the LQF group support indication from the RAN node, the SMF may proceed with configuring the UPF to identify ME SDFs, using LQF configuration IEs. Otherwise, if the RAN node does not support LQF groups, the SMF may in some cases reject the request from the AF, or in some cases, the SMF may proceed with using data boosting without using LQF groups, e.g., accepting that in this instance the RAN access control may be inaccurate.

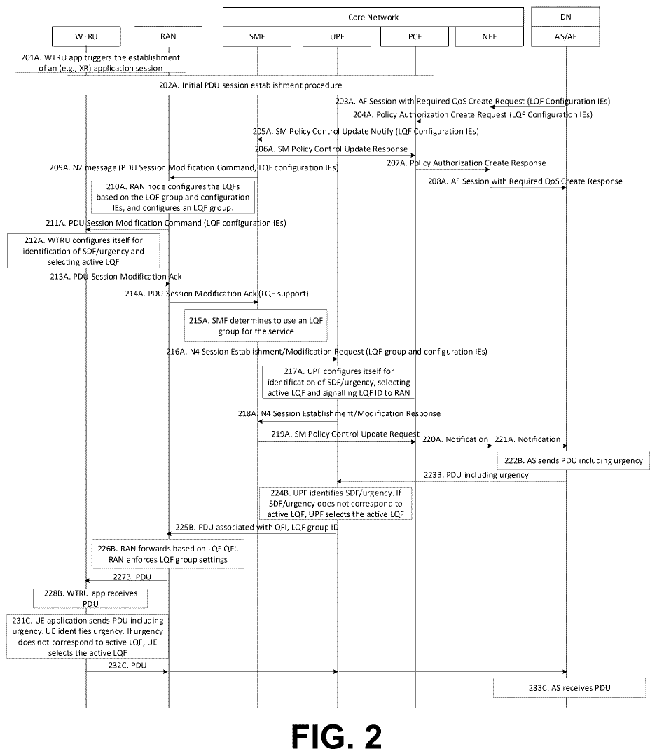

FIG. 2 illustrates a signaling diagram of an example procedure for the configuration and operation of a LQF group, according to an embodiment. As illustrated in the example of FIG. 2, at 201A, the WTRU application triggers the establishment of an (e.g., XR, AR or VR) application session. At 202A, the WTRU and the network perform an initial PDU session establishment or modification procedure, which completes with the creation or modification of a PDU session to enable communication between the WTRU and the AS.

As further illustrated in the example of FIG. 2, at 203A, the AF sends to the NEF an AF Session with Required QoS Create Request message including LQF Configuration IEs, to enable the use of expedited forwarding for the application flow as discussed above. If it is trusted by the mobile network, the AF may alternatively directly send a Policy Authorization Create Request message to the PCF. At 204A, the NEF (or trusted AF) sends to the PCF a Policy Authorization Create Request message including LQF Configuration IEs. The PCF configures PCC rules including LQF Configuration IEs as discussed above. At 205A, the PCF sends to the SMF a SM Policy Control Update Notify message including LQF Configuration IEs.

In the example of FIG. 2, at 206A, the SMF sends an SM Policy Control Update Response message to the PCF. At 207A, the PCF sends a Policy Authorization Create Response message to the NEF (or trusted AF). At 208A, the NEF sends an AF Session with Required QoS Create Response message to the AF. At 209A, the SMF determines to use an LQF group and sends a N2/NAS message (e.g., N2 message including a PDU Session Modification Command) to the RAN, including LQF configuration IEs as discussed above.

As illustrated in the example of FIG. 2, at 210A, the RAN node configures itself with the LQFs based on the LQF group and configuration IEs and configures an LQF group as discussed above. The RAN may implement optimizations and may perform LQF-related actions such as accurate access control as discussed above. At 211A, the RAN node forwards to the UE the PDU Session Modification Command message, including LQF configuration IEs as discussed above.

In the example of FIG. 2, at 212A, the WTRU configures itself for identification of the SDF (e.g., including identifying the urgency indication) and selecting an active LQF as discussed above. At 213A, the WTRU sends a PDU Session Modification Ack message to the RAN node. At 214A, the RAN node forwards the PDU Session Modification Ack message to the SMF. In some embodiments, the RAN node may include an LQF support indication to the message prior to forwarding it as discussed above.

As illustrated in the example of FIG. 2, at 215A, the SMF may re-evaluate its decision to use an LQF group for the service, e.g., based on the LQF support indication as discussed above. At 216A, the SMF sends to the UPF an N4 Session Establishment/Modification Request message including LQF group configuration IEs as discussed above. At 217A, the UPF configures itself for identification of SDF (e.g., including identifying the urgency indication), selecting active LQF and signalling the active LQF to RAN as discussed above. At 218A, the UPF sends to the SMF an N4 Session Establishment/Modification Response message. At 219A, 220A and 221A, the SMF sends to the PCF an SM Policy Control Update Request message, which triggers the PCF to sends a notification to the AF through the NEF (or directly to the trusted AF).

It is noted that procedures 201A to 221A discussed above may generally relate to the configuration of an LQF group, according to certain embodiments.

In the example of FIG. 2, at 22B and 223B, the AS sends a PDU including an urgency indication with a value corresponding to one of the linked SDFs. At 224B, the UPF identifies the SDF (e.g., including identifying the urgency indication). If the SDF/urgency does not correspond to the active LQF, the UPF selects the active LQF as discussed above.

As illustrated in the example of FIG. 2, at 225B, the UPF sends a PDU associated with (e.g., encapsulated with a GTP-U header including) a QFI, and in some examples, also an LQF group ID. At 226B, the RAN forwards based on LQF QFI. Prior to forwarding, the RAN may enforce LQF group settings and perform other LQF-related actions such as storing counters for LQF group reporting as discussed above. At 227B and 228B, the WTRU receives the PDU from the RAN and provides it to the UE application.

It is noted that procedures 222B to 228B discussed above may generally relate to the transmission of an DL PDU using an LQF group.

In the example of FIG. 2, at 231C, the WTRU (e.g., the WTRU application) sends a PDU including an urgency indication with a value corresponding to one of the linked SDFs. The WTRU identifies the urgency indication. If the urgency indication value does not correspond to an active LQF, the WTRU selects the active LQF as discussed above. The WTRU may also enforce LQF group settings and/or perform other LQF-related actions such as storing counters for LQF group reporting as discussed above. As shown at 232C and 233C, the PDU is forwarded through the network and the AS receives the PDU.

It is noted that procedures 231C to 233C discussed above may generally relate to the transmission of an UL PDU using an LQF group.

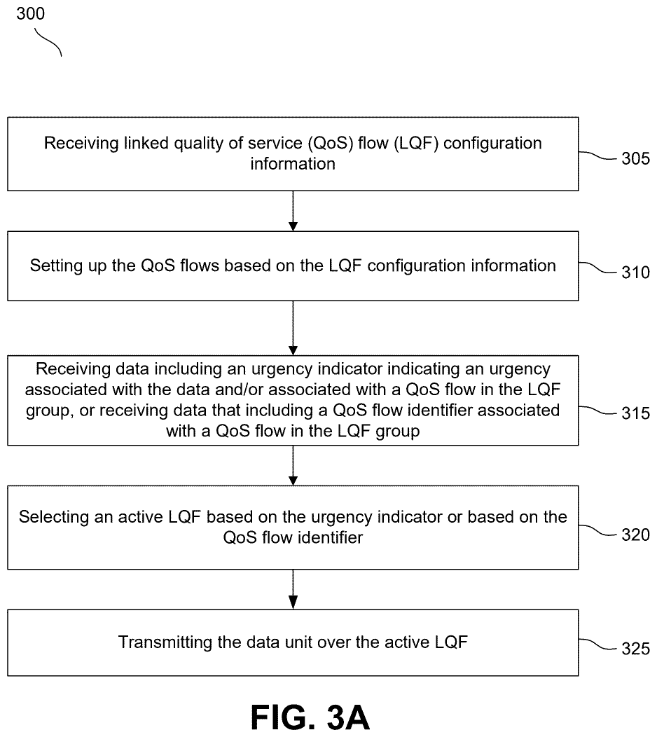

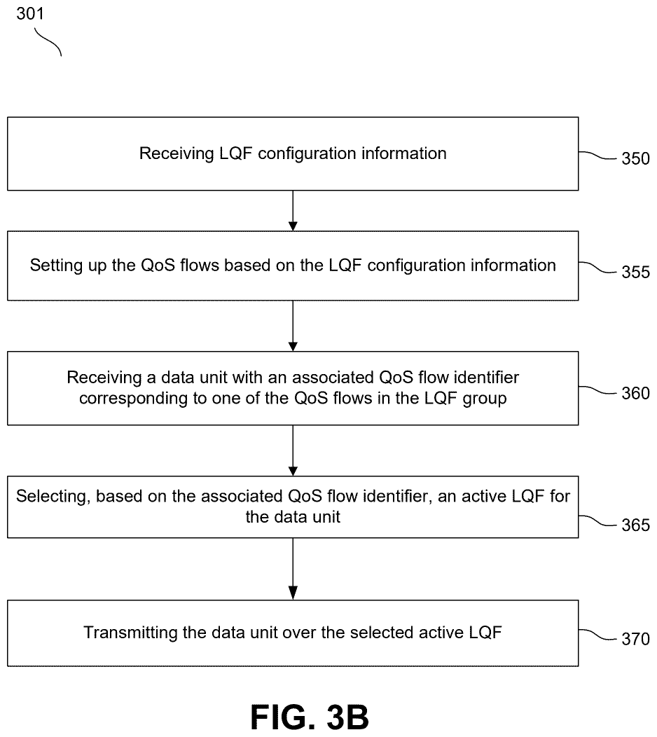

FIG. 3A illustrates an example flow diagram of a method 300 for or relating to linked QoS flow (LQF) configuration and/or operation, according to some embodiments. The example method 300 of FIG. 3A and accompanying disclosures herein may include, may be based on, or may be a synthesization of various embodiments or elements discussed in detail above.

For convenience and simplicity of exposition, the example of FIG. 3A may be described with reference to the architecture or system described above with respect to FIGS. 1A-1D, for instance. However, the example method 300 depicted in FIG. 3A may be carried out using different architectures as well. According to some embodiments, the method 300 of FIG. 3A may be performed or implemented by a UE or WTRU, such as the WTRU 102 described in the foregoing or the WTRU illustrated in the example of FIG. 2.

It is noted that the method 300 of FIG. 3A may include further steps, procedures or details as discussed in detail elsewhere in this disclosure. As such, the method 300 of FIG. 3A may be modified to include any of the steps, procedures, elements and/or details illustrated and/or discussed in the foregoing.

Moreover, it is noted that the method and/or blocks of FIG. 3A may be modified to include, or to be replaced by, any one or more of the procedures, elements or blocks discussed elsewhere herein. As such, one of ordinary skill in the art would understand that FIG. 3A is provided as one example and modifications thereto are possible while remaining within the scope of certain example embodiments.

As illustrated in the example of FIG. 3A, the method 300 may include, at 305, receiving linked quality of service (QoS) flow (LQF) configuration information. The LQF configuration information may include or may indicate any one or more of: one or more QoS flows (e.g., an indication or identifier of one or more QoS flows, a profile associated with each of the QoS flows, or other information associated with or identifying characteristics of the QoS flows), a mutually exclusive indication indicating that the QoS flows are used mutually exclusively as discussed in detail above, an identifier associated with a LQF group that includes or is made up of at least some of the QoS flows.

In an embodiment, the method 300 may include, at 310, setting up (or otherwise configuring or preparing) the QoS flows based on the LQF configuration information.

In an embodiment, the method 300 may include, at 315, receiving a data unit (e.g., a PDU, set of PDUs, packet(s), data or the like) that may include an urgency indicator indicating an urgency associated with the data unit and/or associated with a QoS flow in the LQF group, or receiving a data unit that may include a QoS flow identifier associated with a QoS flow in the LQF group.

In an embodiment, the method 300 may include, at 320, selecting an active LQF, based on the urgency indicator or based on the QoS flow identifier. At 325, the method 300 may include transmitting the data unit over the active LQF.

According to some embodiments, the data unit may be an UL protocol data unit (PDU) or a DL protocol data unit (PDU).

In certain embodiments, the LQF configuration information may further include or indicate characteristics associated with the LQF group such as any one or more of: a LQF transition timing (or minimum selection time), a priority associated with each of the QoS flows, and/or a degraded mode indication, as discussed in detail above.

According to an embodiment, the selecting of the active LQF at 320 may be further based on the characteristics associated with the LQF group.

In an embodiment, based on the mutually exclusive indication, the method may include limiting, by the WTRU or other node, a rate of change between active LQFs as discussed in detail above.

According to an embodiment, the method 300 may include updating one or more counters related to the LQF group. For example, the one or more counters may be configured to monitor a number of packets or bytes associated with the one of the QoS flows in the LQF group.

FIG. 3B illustrates an example flow diagram of a method 301 for or relating to linked QoS flow (LQF) configuration and/or operation, according to some embodiments. The example method 301 of FIG. 3B and accompanying disclosures herein may include, may be based on, or may be a synthesization of various embodiments or elements discussed in detail above.

For convenience and simplicity of exposition, the example of FIG. 3B may be described with reference to the architecture or system described above with respect to FIGS. 1A-1D, for instance. However, the example method 301 depicted in FIG. 3B may be carried out using different architectures as well. According to some embodiments, the method 301 of FIG. 3B may be performed or implemented by a network element or node, such as the RAN node described in the foregoing and illustrated in the example of FIG. 2.

It is noted that the method 301 of FIG. 3B may include further steps, procedures or details as discussed in detail elsewhere in this disclosure. As such, the method 301 of FIG. 3B may be modified to include any of the steps, procedures, elements and/or details illustrated and/or discussed in the foregoing.

Moreover, it is noted that the method and/or blocks of FIG. 3B may be modified to include, or to be replaced by, any one or more of the procedures, elements or blocks discussed elsewhere herein. As such, one of ordinary skill in the art would understand that FIG. 3B is provided as one example and modifications thereto are possible while remaining within the scope of certain example embodiments.

As illustrated in the example of FIG. 3B, the method 301 may include, at 350, receiving LQF configuration information. For example, the LQF configuration information may include or may indicate any one or more of: one or more profiles associated with QoS flows (e.g., each QoS flow may have an associated profile), a mutually exclusive indication indicating that the QoS flows are used mutually exclusively, and/or an identifier associated with a LQF group that includes or is made up of at least some of the QoS flows.

It is noted that, in some embodiments, there may be at least two QoS flows (e.g., a first QoS flow and a second QoS flow, etc.) and each QoS flow may have an associated profile that may be different or the same (e.g., two or more QoS flows may share the same profile and/or some or each may have different associated profiles).

In the example of FIG. 3B, the method 301 may include, at 355, setting up, or otherwise configuring or preparing, the QoS flows based on the LQF configuration information. At 360, the method 301 may include receiving a data unit (e.g., PDU, PDU set, packet(s), data, or the like) with an associated QoS flow identifier corresponding to one of the QoS flows in the LQF group.

As illustrated in the example of FIG. 3B, the method 301 may include, at 365, selecting, based on the associated QoS flow identifier, an active LQF for the data unit. At 370, the method 301 may include transmitting the data unit over the selected active LQF.

In an embodiment, the LQF configuration information may further include or indicate characteristics associated with the LQF group such as any one or more of: a LQF transition timing, a priority associated with each of the QoS flows, and a degraded mode indication.

According to an embodiment, the selecting at 365 of the active LQF is further based on any of the characteristics associated with the LQF group and/or characteristics associated with a currently active LQF.

In an embodiment, if the selected active LQF is invalid (e.g., determined to be invalid), the method 301 may include sending an error indication to another network element, dropping the data unit, and/or selecting a currently active linked QoS flow (LQF).

According to an embodiment, the method 301 may include updating one or more counters related to the LQF group. For example, the one or more counters may be configured to monitor a number of packets or bytes associated with the one of the QoS flows in the LQF group.

In an embodiment, the method 301 may include performing access control operations using the characteristics associated with the LQF group and/or the linked quality of service (QoS) flow (LQF) configuration information, as discussed in detail above.

It is noted that the flow diagrams illustrated in FIGS. 3A and 3B are provided as one example, and modifications thereto are contemplated according to certain embodiments as discussed elsewhere herein. For example, one or more of the steps illustrated in FIG. 3A or 3B may be omitted, combined, modified and/or performed in a different order, as provided in the example embodiments discussed herein.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### ABBREVIATIONS AND ACRONYMS

5GS 5G System
AF Application Function
API Application Programing Interface
AS Application Server
CPU Central Processing Unit
DN Data Network
DNN Data Network Name
FQDN Fully Qualified Domain Name
GBR Guaranteed Bit Rate
GTP-U Generic Tunneling Protocol User Plane
ID Identifier
IE Information Element
IP Internet Protocol (IPv4: IP version 4, IPv6: IP version 6)
LQF (as defined herein) Linked QoS Flow
ME (as defined herein) Mutually Exclusive
MOQ Media over QUIC
MTU Maximum Transmission Unit
N2 Interface defined by 3GPP between AMF and RAN (the AMF transparently relays
N2 SM information messages between the SMF and RAN)
N4 Interface defined by 3GPP between SMF and UPF
NAS Non-Access Stratum
NEF Network Exposure Function
PCF Policy Control Function
PDU Protocol Data Unit
PSA UPF PDU Session Anchor UPF
QFI QoS Flow ID
QoE Quality of Experience
QoS Quality of Service
RAN Radio Access Network
RTP Real-Time Protocol
SMF Session Management Function
UDP User Datagram Protocol
UE User Equipment
UPF User Plane Function
URSP UE Route Selection Policy
XR Extended Reality

What is claimed is:

1. A network element, comprising:
circuitry, including any of a processor, transmitter, receiver, and memory, configured to
receive linked quality of service (QoS) flow (LQF) configuration information indicating any of (1) one or more profiles associated with QoS flows (2) a mutually exclusive indication indicating that the QoS flows are used mutually exclusively, and (3) an identifier associated with a linked QoS flow (LQF) group comprising the QoS flows;
set up the QoS flows based on the linked QoS flow (LQF) configuration information;
receive a data unit with an associated QoS flow identifier corresponding to one of the QoS flows in the linked QoS flow (LQF) group;
select, based on the associated QoS flow identifier, an active linked QoS flow (LQF) for the data unit; and
transmit the data unit over the selected active linked QoS flow (LQF).

2. The network element of claim 1, wherein the linked QoS flow (LQF) configuration information further indicates characteristics associated with the linked QoS flow (LQF) group comprising any of: a linked QoS flow (LQF) transition timing, a priority associated with each of the QoS flows, and a degraded mode indication.

3. The network element of claim 2, wherein the selection of the active linked QoS flow (LQF) is further based on any of the characteristics associated with the linked QoS flow (LQF) group and characteristics associated with a currently active linked QoS flow (LQF).

4. The network element of claim 1, wherein, on condition that the selected active linked QoS flow (LQF) is determined to be invalid, the circuitry is configured to:
send an error indication to another network element;
drop the data unit; or
select a currently active linked QoS flow (LQF).

5. The network element of claim 1, wherein the circuitry is configured to update one or more counters related to the linked QoS flow (LQF) group, wherein the one or more counters are configured to monitor a number of packets or bytes associated with the one of the QoS flows in the linked QoS flow (LQF) group.

6. The network element of claim 1, wherein the circuitry is configured to perform access control operations using the linked quality of service (QoS) flow (LQF) configuration information.

7. The network element of claim 1, wherein the data unit comprises a protocol data unit (PDU).

8. A wireless transmit/receive unit (WTRU), comprising:
circuitry, including any of a processor, transmitter, receiver, and memory, configured to
receive linked quality of service (QoS) flow (LQF) configuration information indicating any of (1) one or more QoS flows (2) a mutually exclusive indication indicating that the QoS flows are used mutually exclusively, and (3) an identifier associated with a linked QoS flow (LQF) group comprising the QoS flows;
set up the QoS flows based on the linked QoS flow (LQF) configuration information;
receive a data unit comprising an urgency indicator indicating an urgency associated with the data unit and a QoS flow in the linked QoS flow (LQF) group, or receive a data unit comprising a QoS flow identifier associated with a QoS flow in the linked QoS flow (LQF) group;
select an active linked QoS flow (LQF), based on the urgency indicator or the QoS flow identifier; and
transmit the data unit over the active linked QoS flow (LQF).

9. The WTRU of claim 8, wherein the data unit comprises an uplink protocol data unit (PDU) or a downlink protocol data unit (PDU).

10. The WTRU of claim 8, wherein the linked QoS flow (LQF) configuration information further indicates characteristics associated with the linked QoS flow (LQF) group comprising any of: a linked QoS flow (LQF) transition timing, a priority associated with each of the QoS flows, and a degraded mode indication.

11. The WTRU of claim 10, wherein the selection of the active linked QoS flow (LQF) is further based on the characteristics associated with the linked QoS flow (LQF) group.

12. The WTRU of claim 8, wherein, based on the mutually exclusive indication, the circuitry is configured to limit a rate of change between active linked QoS flows (LQFs).

13. The WTRU of claim 8, wherein the circuitry is configured to update one or more counters related to the linked QoS flow (LQF) group, wherein the one or more counters are configured to monitor a number of packets or bytes associated with the one of the QoS flows in the linked QoS flow (LQF) group.

14. A method, implemented by a wireless transmit/receive unit (WTRU), the method comprising:
receiving linked quality of service (QoS) flow (LQF) configuration information indicating any of (1) one or more QoS flows (2) a mutually exclusive indication indicating that the QoS flows are used mutually exclusively, and (3) an identifier associated with a linked QoS flow (LQF) group comprising the QoS flows;
setting up the QoS flows based on the linked QoS flow (LQF) configuration information;
receiving a data unit comprising an urgency indicator indicating an urgency associated with the data unit and a QoS flow in the linked QoS flow (LQF) group, or receiving a data unit comprising a QoS flow identifier associated with a QoS flow in the linked QoS flow (LQF) group;
selecting an active linked QoS flow (LQF), based on the urgency indicator or the QoS flow identifier; and
transmitting the data unit over the active linked QoS flow (LQF).

15. The method of claim 14, wherein the data unit comprises an uplink protocol data unit (PDU) or a downlink protocol data unit (PDU).

16. The method of claim 14, wherein the linked QoS flow (LQF) configuration information further indicates characteristics associated with the linked QoS flow (LQF) group comprising any of: a linked QoS flow (LQF) transition timing, a priority associated with each of the QoS flows, and a degraded mode indication.

17. The method of claim 16, wherein the selecting of the active linked QoS flow (LQF) is further based on the characteristics associated with the linked QoS flow (LQF) group.

18. The method of claim 14, comprising, based on the mutually exclusive indication, limiting a rate of change between active linked QoS flows (LQFs).

19. The method of claim 14, comprising updating one or more counters related to the linked QoS flow (LQF) group, wherein the one or more counters are configured to monitor a number of packets or bytes associated with the one of the QoS flows in the linked QoS flow (LQF) group.
